(19) United States
(12) Patent Application Publication
(10) Pub. No.: US 2010/0162961 A1
(43) Pub. Date: Jul. 1, 2010

(54) Pet Feeder

(76) Inventors: Craig Hove, Santa Barbara, CA (US); Todd Hove, La Mesa, CA (US)

Correspondence Address: G. L. LOOMIS & ASSOCIATES, INC., 990 HIGHLAND DRIVE, SUITE 212Q, SOLANA BEACH, CA, 92075, US

(21) Appl. No.: 12/345,546

(22) Filed: Dec. 29, 2008

(51) Int. Cl. A01K 1/10; A01K 7/00

(52) U.S. Cl. 119/51.5; 119/61.53

(57) ABSTRACT

The present invention relates to an animal feeding devices that protect food in a pet food dish or bowl from infestation by crawling insects such as ants. The devices consists of a table with a flat top and four legs wherein each leg is surrounded by a liquid reservoir, which when filled with a suitable liquid, functions by presenting a liquid barrier to crawling insects thereby excluding the insects from the table top. The table top has one or more openings sized to accommodate a rimmed feed bowl or rendering the bowl stationary for a feeding pet. Certain embodiments also provide a liquid supply vessel for maintaining a suitable level liquid in the reservoirs.

### FIELD OF THE INVENTION

The present invention relates to an animal feeding device. More particularly, the invention relates a device for protecting a pet food dish from crawling insects.

### BACKGROUND OF THE INVENTION

Food dishes for pets often become infested with crawling insects such as ants, especially when the bowl is placed outdoors. Thus a need exists for a pet-feeding device that will prevent ants and other crawling insects from infesting the food that has been provided for pet. Various types of insect repelling pet dishes are described in the art. A typical example of an insect inhibiting pet dish can be found in U.S. Pat. No. 4,128,080 to Haney, which discloses a food dish supported on a pillar above a water dish allowing the pet to both drink from the lower water dish and eat from the raised food dish. U.S. Pat. No. 5,277,149 to East as well as U.S. Pat. No. 6,860,229 to Craft also describes pet feeding devices that combine a food dish with a water dish. However, while these devices may be useful for protecting the raised food dish from ants and other crawling insects, they allows the water dish to become infested with insects thereby contaminating the pet's drinking water.

U.S. Pat. No. 5,881,671 to Riedl describes a pet feeder comprising a tripod stand for a food dish wherein the base legs are surrounded by a tube and a circular disk which presents a purely physical barrier to ants. Furthermore, such devices comprising single legged or tripod dish stands suffers from an inherent instability and are easily tipped over by a feeding pet.

U.S. Pub. Pat. App. 2004/0244703 to Lehman describes an insect resistant food container for pets that uses a sticky polymer trap, which may also contain a chemical pesticide, under the rim of a bowl to trap insects and prevent them from reaching the food. Such sticky polymer traps must be purchased and replaced on a continuing basis and the chemicals present in the sticky trap may be injurious to the health of the pet.

Therefore, it can be appreciated that there exists a continuing need for an improved pet-feeding device that effectively prevents ants and other crawling insects from infesting a pet's food. It is further appreciated that there exists a need for a pet feeding device with the mechanical stability withstand the movement imparted thereto and cannot be easily tipped over by a feeding pet. It is still further appreciated that there exists a need for a pet feeding device that is easy to clean and maintain and that does not rely on potentially toxic chemicals. The present invention substantially fulfills these and other needs.

### BRIEF DESCRIPTION OF THE DRAWINGS

FIG. 1 is a partially exploded isometric view of an embodiment of the present invention.

FIG. 2 is a frontal orthographic view of the embodiment depicted in FIG. 1.

FIG. 3 is a sectional end orthographic view of the embodiment depicted in FIG. 1.

FIG. 4 is a partially exploded isometric view of an embodiment of the present invention.

FIG. 5 is a top orthographic view of the embodiment depicted in FIG. 4.

FIG. 6 is a sectional frontal orthographic view of the embodiment depicted in FIG. 4.

FIG. 7 is an isometric view of an embodiment of the present invention.

FIG. 8 is a top orthographic view of the embodiment depicted in FIG. 7.

FIG. 9 is a sectional end orthographic view of the embodiment depicted in FIG. 7.

FIG. 10 is a frontal orthographic view of the embodiment depicted in FIG. 7.

FIG. 11 is an isometric view of an embodiment of the present invention wherein the apparatus has an alternative water storage container.

FIG. 12 is a top orthographic view of the embodiment depicted in FIG. 11.

FIG. 13 is sectional front orthographic view of a leg detail of the embodiment depicted in FIG. 11.

FIG. 14 is an isometric view of an embodiment of the present invention wherein the apparatus has an alternative water storage container.

FIG. 15 is a top orthographic view of the embodiment depicted in FIG. 14.

FIG. 16 is sectional front orthographic view of a leg detail of the embodiment depicted in FIG. 14.

FIG. 17 is an isometric view of an embodiment of the present invention wherein the apparatus a pet's water-bowl also functions as a storage container for filling the leg reservoirs.

FIG. 18 is a front orthographic view of the embodiment depicted in FIG. 17.

FIG. 19 is sectional front orthographic view of the bowl detail of the embodiment depicted in FIG. 17.

Although the figures illustrate preferred embodiments of the invention they are intended to be merely exemplary and representative of certain embodiments. To that end, several figures contain optional features that need not be included in any particular embodiment of the invention and the shape, type, or particular configuration of the various elements of the devices illustrated should not be regarded as limiting to the invention.

### SUMMARY OF THE INVENTION

The present invention relates to an animal feeding devices that protect food in a pet food dish or bowl from infestation by crawling insects such as ants. In general pet-feeding devices of the present invention consists of a table with a flat top and four support legs wherein each leg is disposed in an outer tube having an open proximal end and a closed distal end such that the tube forms a liquid reservoir surrounding each support leg. The liquid reservoirs are filled with a liquid which functions by presenting a liquid barrier to crawling insects. Also, the liquid in the reservoir is generally inaccessible for drinking by a pet by virtue of the geometry of the reservoir as well as the placements of the reservoir beneath the top of the table. The top of the table has one or more openings sized to accommodate a rimmed feed bowl such that body of the bowl fits through opening and the rim, which is larger than the opening, maintains intimate contact with the top surface of the table and essentially hold the bowl in place. Such an arrangement provides a stationary food bowl for a feeding pet.

Certain embodiments of the present invention provide a pet-feeding device as described above that also have a liquid supply vessel disposed below the bottom surface of the table top wherein the liquid supply vessel has a fill opening and four liquid delivery tubes each in liquid communication with the reservoirs surrounding the legs such that the reservoirs are maintained with a suitable level liquid from the supply vessel by the action of gravity. In such embodiments, the top of the table is provided with an opening or hole disposed directly above the liquid supply vessel fill opening so that the liquid supply vessel can be conveniently filled with liquid from above the table top.

Certain other embodiments a pet feeding device with a liquid supply vessel as is described above is also provided with a bottle such as a plastic beverage bottle, wherein the bottle fits through the opening in the table that is above the supply vessel fill opening and wherein the neck of the bottle extends through the supply vessel fill such that the bottle can be filled with liquid, inverted and have the neck inserted into the fill opening to replenish liquid to the supply vessel by the action of gravity. In such an embodiment the opening in the table top through which the bottle is disposed serves to hold the bottle in place while the neck of the bottle is inserted into the fill opening in the supply vessel.

In certain embodiments of the pet feeding device having a liquid supply vessel the four liquid delivery tubes each have a proximal end disposed within the liquid supply vessel and a distal end extending into a leg assembly reservoir wherein the distal end comprises a ball float that closes when the leg assembly reservoir is full.

In certain embodiment of the pet feeding device each outer tube comprises an upper outer tube element and a lower outer tube element relatively disposed to provide a space between the upper and lower outer tube elements such that each support leg and each lower outer tube element define each leg assembly reservoir and wherein the space is sized to prevent a pet from accessing the contents of the leg assembly reservoirs. The space between the upper and lower outer tube elements is, however, sufficient to prevent ants and other crawling insects from crossing the space.

In certain other embodiments of the pet feeding device of the present invention the flat rectangular bed has at least two feed bowl openings and a liquid supply vessel with a fill opening and four liquid delivery tubes wherein each delivery tube is in liquid communication with a leg assembly reservoir such that the leg assembly reservoirs are maintained with a suitable level liquid from the liquid supply vessel by the action of gravity. In such embodiments the liquid supply vessel is disposed below the bottom surface of the rectangular bed directly under one of the feed bowl openings and a rimmed water bowl is disposed within the feed bowl opening, wherein the rimmed water bowl has a bottom opening that allows water in the water bowl to enter the liquid supply vessel and wherein the bottom opening is provided with a ball float that closes when the liquid supply vessel is full.

In certain preferred embodiments of the pet feeding devices of the present invention the closed distal end of the outer tube that forms the liquid reservoir surrounding each table support leg is flared to provide a stabilizing foot to each of the legs.

In certain other preferred embodiments of the pet feeding devices of the present invention the open proximal end of the outer tube that forms the liquid reservoir surrounding each table support leg is flared to provide a funnel cone that functions as an aid for adding liquid the reservoirs.

### DETAILED DESCRIPTION OF THE INVENTION

The pet-feeding devices of the present invention essentially consist of a table comprising a flat rectangular bed having a top surface, a bottom surface and four corners and four leg assemblies each comprising a support leg with a proximal end attached to the underside of one corner of the rectangular bed. Each support leg is concentrically disposed within an outer tube having an open proximal end and a closed distal end, wherein the distal end of the support leg is fixedly attached to the closed distal end of the outer tube. The relative diameters and relative lengths of the support legs to the outer tubes are chosen to define a leg assembly reservoir capable of retaining a liquid surrounding each support leg such that the leg assembly reservoirs can be filled with a liquid to present a liquid barrier to crawling insects while maintaining the liquid inaccessible for drinking by a pet. The flat rectangular bed is configured to define at least one feed bowl opening that is sized to accommodate a bowl having a body and a rim such that the underside of the rim is in intimate contact with the top surface of the rectangular bed around the periphery of the opening when the body of the bowl is disposed below the top surface of the flat rectangular bed.

Certain embodiments of the pet feeding device as described above also have a liquid supply vessel disposed below the bottom surface of the rectangular bed. The liquid supply vessel is provided with an opening for filling the vessel and four liquid delivery tubes each in liquid communication with the leg assembly reservoirs such that the leg assembly reservoirs are maintained with a suitable level liquid from the liquid supply vessel by the action of gravity. In such embodiments the flat rectangular bed is configured to define a supply vessel access opening disposed directly above the liquid supply vessel fill opening such that the liquid supply vessel can be filled with liquid through the supply vessel access opening.

Certain other embodiments the pet feeding device as described above are also provided with a bottle having a bottle body and a neck. The body of the bottle is sized to fit through the supply vessel access opening and the neck is sized to extend through the fill opening such that the bottle can be filled with liquid, inverted and inserted through the supply vessel access opening with the neck extending through the fill opening to replenish liquid to the supply vessel by the action of gravity.

In certain preferred embodiments of the pet feeding devices as described above the proximal ends of the outer tube elements are flared to provide a funnel cone which functions as an aid to adding liquid the support leg reservoirs.

In certain other preferred embodiments of the pet feeding devices as described above the distal ends of the outer tube elements are flared to provide stabilizing feet to the leg assemblies.

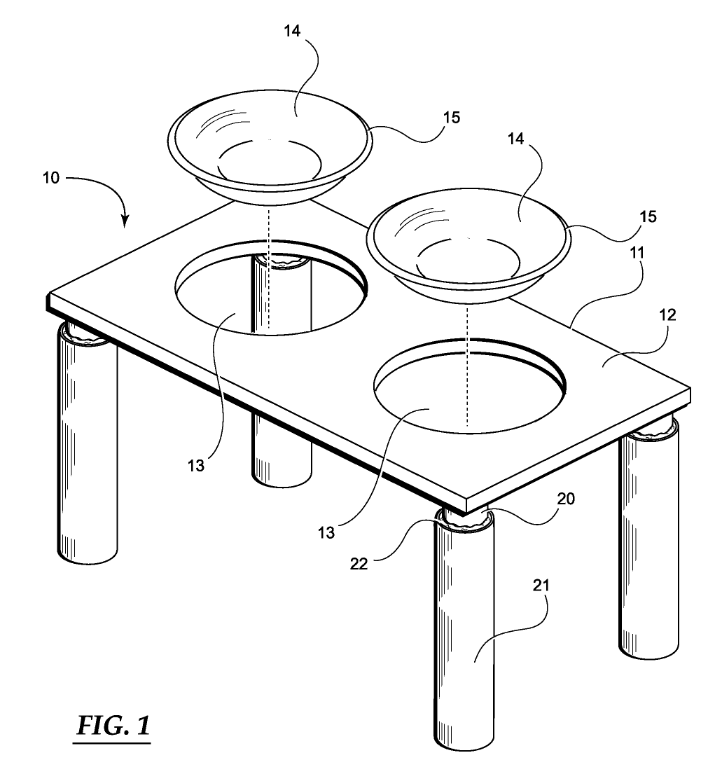

A typical embodiment of the present invention is presented in FIG. 1 which depicts a pet feeder 10 consisting of a table with a flat rectangular bed 11 and a four leg assemblies each comprising a support leg 20 each with the proximal end attached to the underside of the rectangular bed at the four corners. For clarity in all of the following figures the illustration reference numbers are applied to only one of the four identical leg assemblies. The flat rectangular bed 11 is configured to define two circular openings 13 with diameters greater than the diameters of the bowl rims 15 and smaller than the diameters of the body of the bowls 14. This geometry permits retention of the rimmed feeding bowls 14 such that the underside of the bowl rims 15 are in intimate contact with rectangular bed top surface 12 around the periphery of the openings 13 while the body of the bowl is disposed below the rectangular top 11. Such a configuration allows the feeding bowls 14 to be easily removed and replaced for filling with food or cleaning while providing stability to the bowls during the feeding of a pet. Each of support legs 20 is concentrically disposed and fixedly attached within an outer tube element 21 having an open proximal end and a closed distal end, wherein the diameters of the four identical support legs 20 and the outer tube elements 21 are chosen to define a support leg reservoir 22 surrounding each support leg 20 and capable of retaining a liquid. The position, relative length and relative diameter of the support legs 20 and the outer tube elements 21 are chosen to allow the reservoir to be filled with liquid while maintaining the liquid inaccessible for drinking by a pet. The liquid filled reservoirs 22 afford a liquid barrier to ants and other such crawling insects, which functions to prevent crawling insects from contaminating the pet food disposed within the bowls. In preferred embodiments the liquid is water.

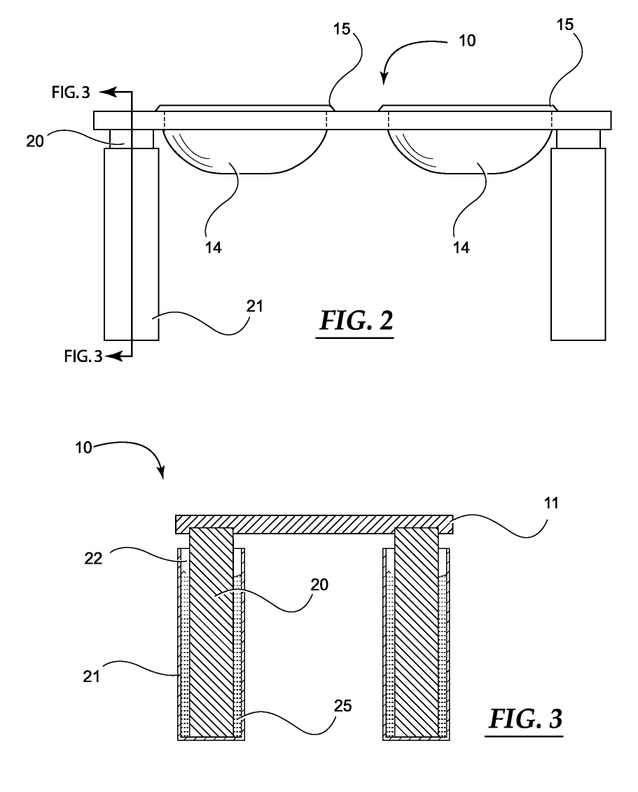

FIG. 2 is an orthogonal frontal view of the embodiment 10 of FIG. 1 depicting the feeding bowls 14 disposed within the flat rectangular bed 11. The retention by the bowl rims 15 of the feeding bowls 14 disposed within the circular openings 13 is clearly illustrated.

FIG. 3 is a sectional end orthographic view of the embodiment 10 depicted in FIG. 1 and FIG. 2 wherein the support leg reservoirs 22 are filled with a liquid 25. FIG. 3 also clearly illustrates that the relative geometries and placements of the components of the pet feeder 10 render the liquid in the support leg reservoirs 22 inaccessible to a feeding pet. Although the support legs 20 outer tube elements 21 defining the support leg reservoirs 22 in the embodiment herein illustrated are depicted as fixedly attached individual components, the support legs 20 and outer tube elements 21 may comprise integral structures. Furthermore although the support legs 20 and the flat rectangular bed 11 in the embodiment herein illustrated are depicted as fixedly attached individual components, the support legs 20 and the flat rectangular bed 11 may comprise integral structures.

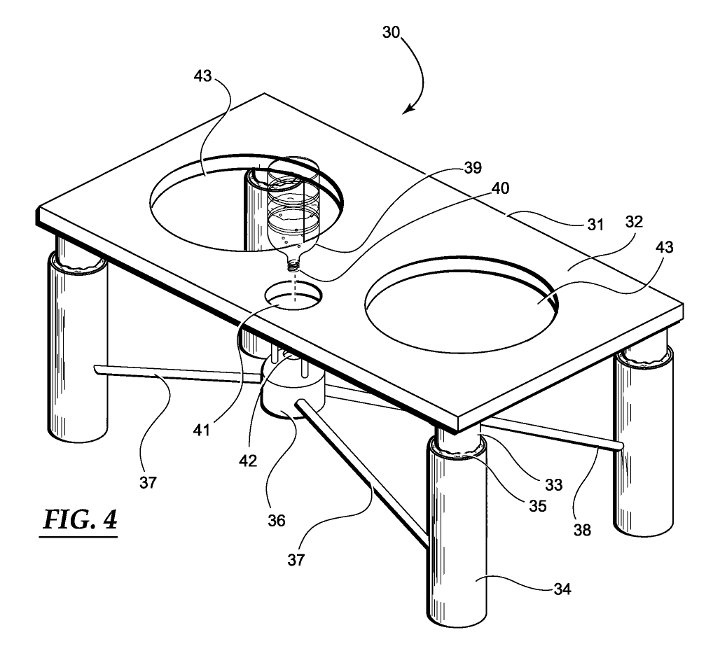

FIG. 4 is a partially exploded isometric view of an embodiment of a pet feeder 30, which is illustrated, for simplicity, without feeding bowls disposed in circular openings 43. The embodiment illustrated as pet feeder 30 is similar to the pet feeder 10 illustrated by FIGS. 1, 2 and 3, wherein pet feeder 30 further comprises a liquid supply vessel 36 that functions to deliver liquid through delivery tubes 37 and 38 to the support leg reservoirs 35 and wherein an inverted bottle 39 that passes through a suitably sized circular opening 41 in the flat rectangular bed 31 and wherein the bottle neck 40 extends through a suitably sized liquid supply vessel opening 42 such that a liquid contained in the bottle 39 can function to replenish liquid to the liquid supply vessel 36. Delivery tubes 37 and 38 are essentially pipes one end of which extend through the wall of the outer tube elements 34 and the other end of which extend through the wall of the liquid supply vessel 36 to function as liquid conduits between the supply vessel 36 and the support leg reservoirs 35.

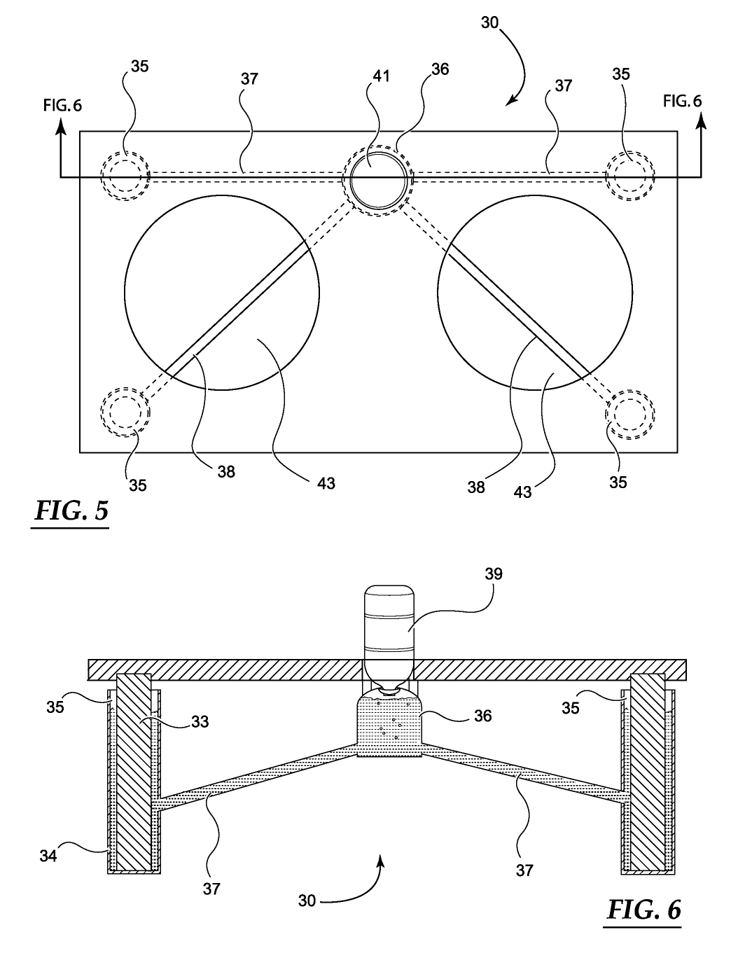

Depicted in FIG. 5 is a top orthographic view of the pet feeder 30 depicted in FIG. 4, which clearly illustrates the spatial relationship between the support leg reservoirs 35, the liquid supply vessel 36 and the delivery tubes 37 and 38.

Depicted in FIG. 6 is a frontal orthographic view of a section, taken as shown in FIG. 5 further illustrating the spatial relationship between the support leg reservoirs 33, the liquid supply vessel 35 and the delivery tubes 34.

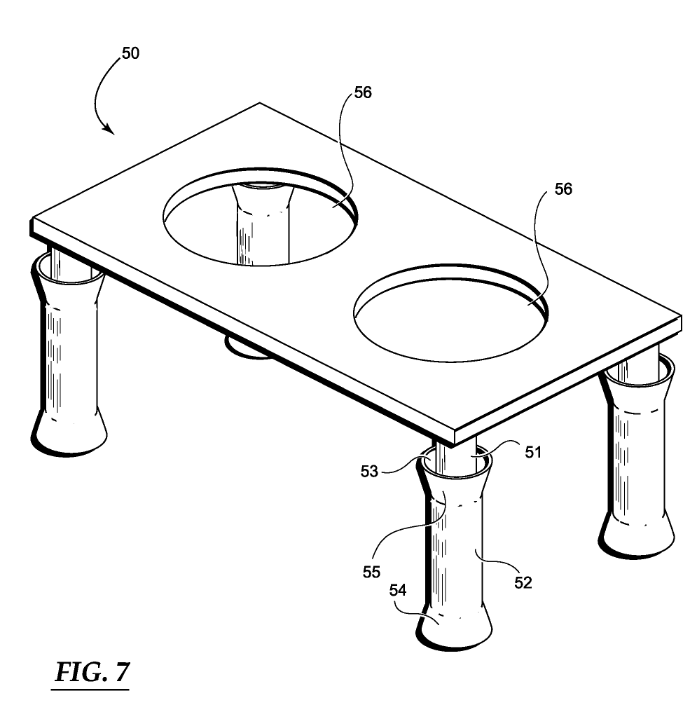

Depicted in FIG. 7 is an isometric view of another embodiment of the present invention shown as pet feeder 50, which is illustrated for simplicity without the feeding bowls disposed within circular openings 56. In this embodiment both the distal and proximal ends of each outer tube elements 52 surrounding the support legs 51 are flared. The distal end flare of the outer tube elements 52 provides a foot 54 that adds to the stability to the pet feeder 50 while functioning to increase the liquid capacity of the support leg reservoirs 53. The proximal end flare of outer tube elements 52 provides a funnel cone 55 for easy filling of the support leg reservoirs 53 while also functioning to increase the liquid capacity.

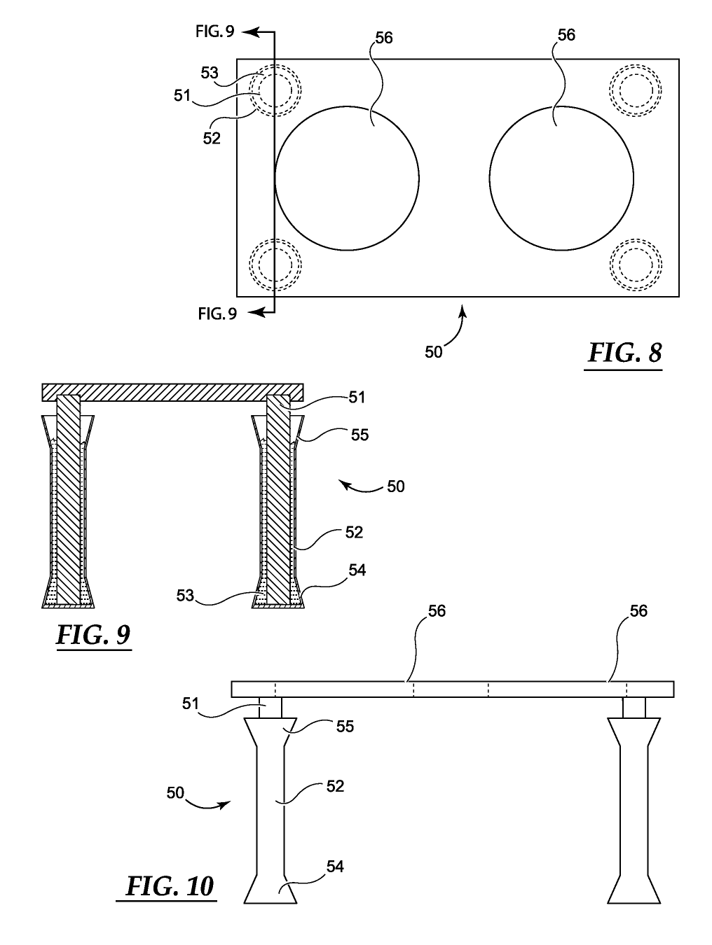

FIG. 8 presents a top orthographic view of the pet feeder 50 depicted in FIG. 7, which illustrates the relationship between the various components. FIG. 10 presents a frontal orthographic view of the pet feeder 50 depicted in FIG. 7, which illustrates the relationship between the various components. In FIG. 10 is illustrated a sectional end orthographic view of the embodiment depicted in FIG. 7, which illustrates the increased liquid volume of the support leg reservoirs 53 afforded by the a foot 54 as well clearly showing the funnel cone 55. In FIG. 9 is presented a sectional frontal orthogonal view of the pet feeder 50 depicted in FIGS. 8 and 10.

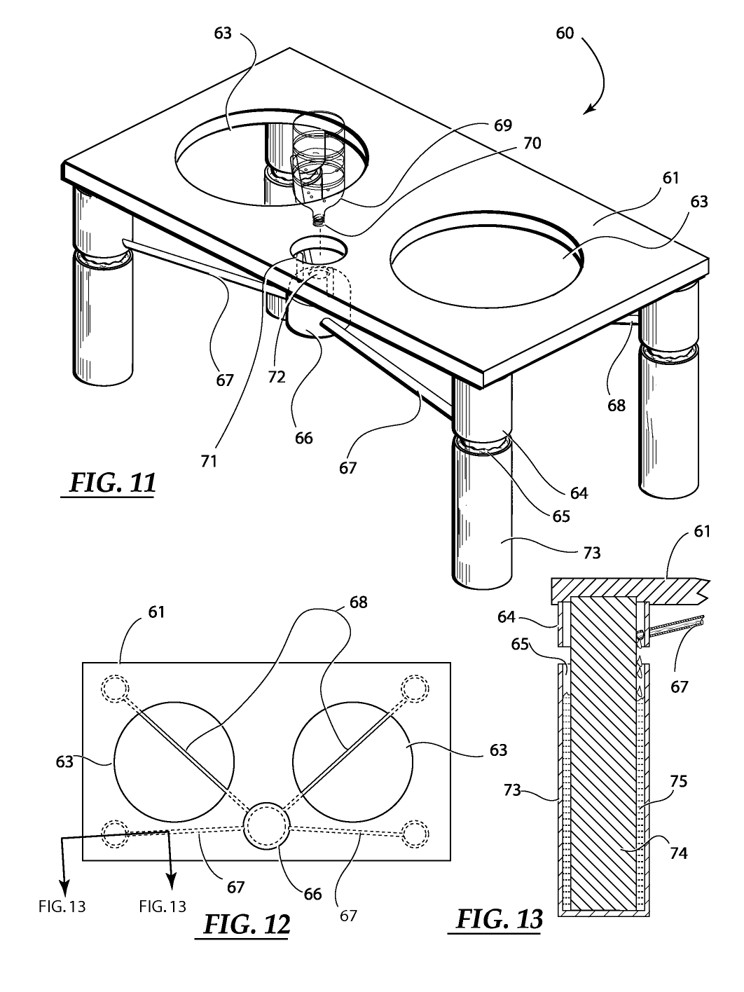

In FIG. 11 is illustrated partially exploded isometric view of an embodiment of a pet feeder 60, which is for clarity shown without feeding bowls disposed in circular openings 63. Pet feeder 60 has a liquid supply vessel 66 that functions to deliver liquid through delivery tubes 67 and 68 to support leg reservoirs 65, which are formed between table legs 74 and lower outer tube elements 73, wherein an inverted bottle 69 passes through a suitably sized circular opening 71 in the flat rectangular bed 61 and wherein the bottle neck 70 extends through a suitably sized liquid supply vessel opening 72 such that a liquid contained in the bottle 69 functions to replenish liquid to the liquid supply vessel 66. Delivery tubes 67 and 68 are essentially pipes one end of which extends through the wall of the outer tube elements 64 and the other end of which extend through the wall of the liquid supply vessel 66 such that delivery tubes 67 and 68 function as liquid conduits between the liquid supply vessel 66 and the support leg reservoirs 65. In such a configuration the liquid drips or runs down along the length of table legs 74 into the support leg reservoirs 65. In FIG. 12 is presented an orthographic top view of pet feeder 60 that clearly illustrates the special relationship between the liquid supply vessel 66; the delivery tubes 67 and 68; and the support leg reservoirs 65. In FIG. 13 is presented a sectional orthographic view a leg detail of the pet feeder 60 that clearly illustrates the location of a delivery tube 67 relative to a support leg reservoir 65. In such an embodiment the delivery tubes 67 and 68 extend through the wall of upper outer tube elements 64 such that a liquid delivered from the liquid supply vessel 66 drips or runs down along the length of table legs 74 to replenish the liquid 75 in the support leg reservoirs 65 that are formed from table legs 74 and lower outer tube elements 73.

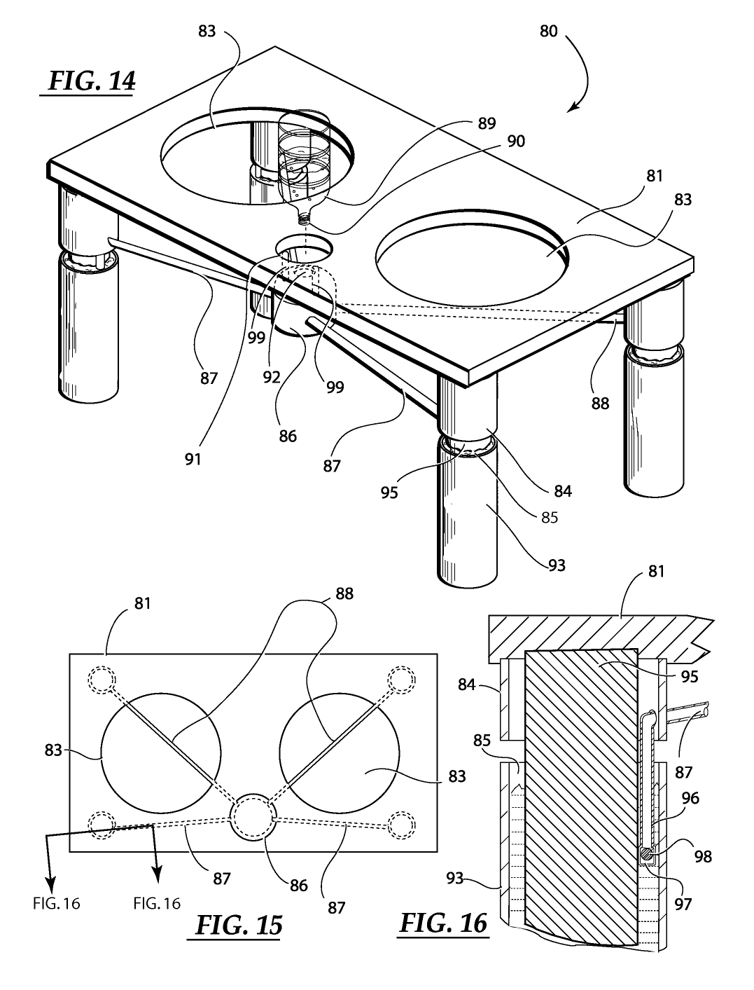

In FIG. 14 is illustrated partially exploded isometric view of an embodiment of a pet feeder 80, which is for clarity shown without feeding bowls disposed in circular openings 83. Pet feeder 80 has a liquid supply vessel 86 that functions to deliver liquid through delivery tubes 87 and 88 to support leg reservoirs 85, which are formed from table legs 94 and lower outer tube elements 83, wherein an inverted bottle 89 passes through a suitably sized circular opening 91 in the flat rectangular bed 81 and wherein the bottle neck 90 extends through a suitably sized liquid supply vessel opening 92 such that a liquid contained in the bottle 89 functions to replenish liquid to the liquid supply vessel 86. Delivery tubes 87 and 88 are essentially pipes one end of which extend through the wall of the outer tube elements 84 and the other end of which extend through the wall of the liquid supply vessel 86 to function as liquid conduits between the liquid supply vessel 86 and the support leg reservoirs 85. In such a configuration the delivery tubes 87 and 88 are essentially L-shaped such that the delivery tube ends 96, which are disposed within the space between outer tube elements 84 and table legs 95, are parallel to table legs 95 and wherein and the delivery tube extremities 97 are disposed at or below the surface of a liquid in the support leg reservoirs 85. Also in this embodiment each delivery tube extremity 97 is provided with a ball float 98 having a density lower that that the liquid used in the system and being disposed within a retainer cage 97 such the ball float 98 functions as a valve to control the delivery of liquid from the liquid supply vessel 86 to the support leg reservoirs 85 that are formed from table legs 95 and lower outer tube elements 93.

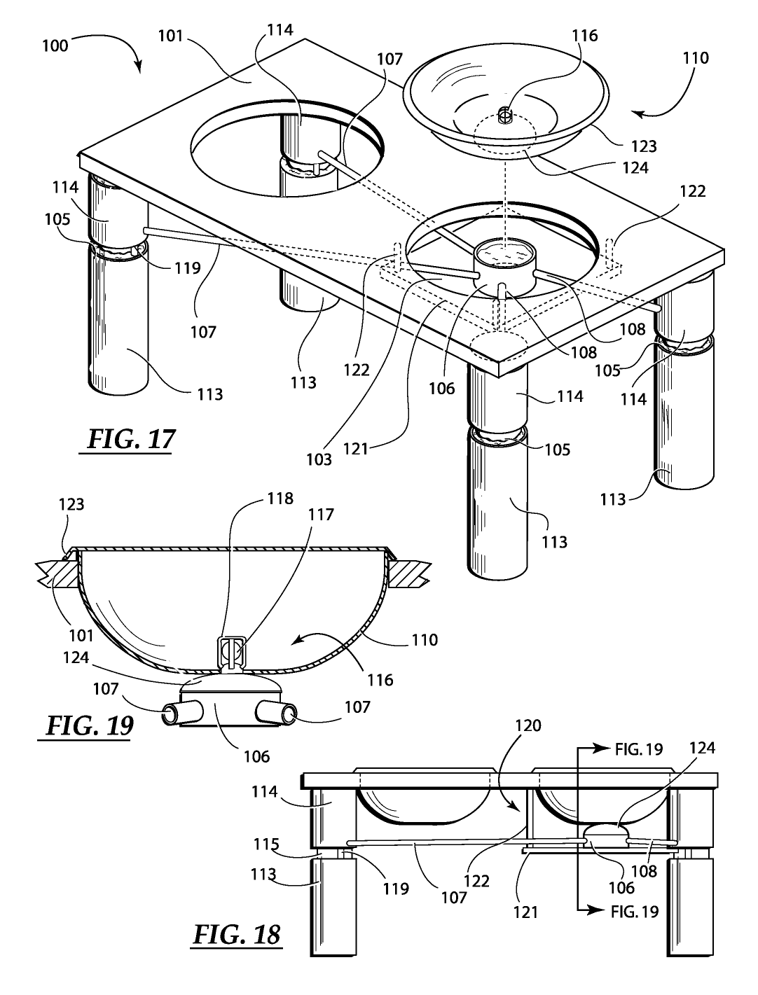

In FIG. 17 is illustrated partially exploded isometric view of an embodiment of a pet feeder 100. In pet feeder 100 has a rimmed water bowl 110 that also functions to feed and replenish liquid supply vessel 106, which in turn delivers water through delivery tubes 107 and 108 to support leg reservoirs 105. The body of rimmed water bowl 110 is sized to fit within circular opening 103 while the water bowl rim 123 rests upon the flat rectangular bed 101. In the bottom of the rimmed water bowl rim 110 is an opening in which is disposed a float valve 116 comprising a float valve ball 117 retained within a cage 118. The float valve ball 117 can be a solid ball fabricated from any suitable material with a density lower that that of water or alternatively the float valve ball 117 can be constructed to be hollow so that the overall density of the float valve ball is lower that that of water. The delivery tubes 107 and 108 function as conduits for water to flow from with the rimmed water bowl 110 and the support leg reservoirs 105. The liquid supply vessel 106 is removedly coupled to the rimmed water bowl 110 by means of a liquid supply vessel cap 124, which is fixedly attached to the bottom of the rimmed water bowl 110. The delivery tubes 107 and 108 are essentially pipes having one end extending through the wall of the outer tube elements 114 and the opposite ends extending through the wall of the liquid supply vessel 106 to function as liquid conduits between the liquid supply vessel 106 and the support leg reservoirs 115. In this embodiment the delivery tubes 107 and 108 are essentially L-shaped such that the delivery tube ends 119, which are disposed within the space between outer tube elements 114 and table legs 115 parallel to table legs 115 and extend to or below the surface of a liquid in the support leg reservoirs 115. The liquid supply vessel 106 is supported by a liquid supply vessel support frame 120 comprising a flat support frame bed 121 attached to the underside of flat rectangular bed 101 by means of four connector pins 122 (only two of which are visible in FIG. 17).

It should be recognized that in the embodiments illustrated in FIGS. 11-18, wherein the support legs are surrounded by upper tube elements and lower tube elements, that the actual liquid barrier to crawling insects is disposed within the space between the upper tube elements and lower tube elements.

Also, although not herein illustrated, certain embodiments of the support leg reservoirs may have removable plugs or stoppers disposed at or near the bottom that provide a convenient means for emptying of the liquid therein and for cleaning of the reservoir.

Suitable materials for fabrication of the various components of devices of the present invention include, but are not limited to, plastics, metals and composites. Certain preferred embodiments are constructed of polyvinyl chloride (PVC). In embodiments comprising liquid supply vessel the liquid delivery tubes may be fabricated from rigid materials such as metal or rigid plastics or from flexible materials such as rubber or flexible plastic.

The relative sizes and dimensions of the components of the pet feeding devices of the present invention are dictated by the size and nature of the pet being feed. Also, the size and number of feeding bowls or dishes are not fixed nor is the exact distribution of bowl openings and liquid supply openings in the top of the table.

Any oil-based or aqueous liquid composition can be employed in the devices of the present invention with water being preferred.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof.

We claim:

1. A pet feeding device comprising:
a flat rectangular bed having a top surface, a bottom surface and four corners; and
four leg assemblies each comprising a support leg with a proximal end attached to the underside of one corner of the rectangular bed, wherein each support leg is concentrically disposed within an outer tube having an open proximal end and a closed distal end, wherein the distal end of the support leg is fixedly attached to the closed distal end of the outer tube, wherein the relative diameters and relative lengths of the support legs to the outer tubes are chosen to define a leg assembly reservoir capable of retaining a liquid surrounding each support leg such that the leg assembly reservoirs can be filled with a liquid to present a liquid barrier to crawling insects while maintaining the liquid inaccessible for drinking by a pet; wherein
the flat rectangular bed is configured to define at least one feed bowl opening sized to accommodate a feed bowl wherein the feed bowl has a body and a rim such that the underside of the rim is in intimate contact with the top surface of the rectangular bed around the periphery of the opening and wherein the body of the bowl is disposed below the top surface of the flat rectangular bed.

2. The pet feeding device of claim 1 further comprising a liquid supply vessel disposed below the bottom surface of the rectangular bed, wherein the liquid supply vessel comprises a fill opening and four liquid delivery tubes emanating from the liquid supply vessel and extending into each leg assembly reservoir to provide liquid communication between the liquid supply vessel and the leg assembly reservoirs such that the leg assembly reservoirs are maintained with a suitable level liquid from the liquid supply vessel by the action of gravity and wherein the flat rectangular bed is configured to define a supply vessel access opening disposed directly above the liquid supply vessel fill opening such that the liquid supply vessel can be filled with liquid through the supply vessel access opening.

3. The pet feeding device of claim 2 wherein each outer tube comprises an upper outer tube element and a lower outer tube element relatively disposed to provide a space between the upper and lower outer tube elements such that each support leg and each lower outer tube element define each leg assembly reservoir and wherein the space is sized to prevent a pet from accessing the contents of the leg assembly reservoirs.

4. The pet feeding device of claim 2 further comprising a bottle with a bottle body and a neck, wherein the bottle body is sized to fit through the supply vessel access opening and the neck is sized to extend through the fill opening such that the bottle can be filled with liquid, inverted and inserted through the supply vessel access opening with the neck extending through the fill opening to replenish liquid to the supply vessel by the action of gravity.

5. The pet feeding device of claim 1 wherein the flat rectangular bed comprises at least two feed bowl openings and further comprises a liquid supply vessel with a fill opening and four liquid delivery tubes wherein each delivery tube is in liquid communication with a leg assembly reservoir such that the leg assembly reservoirs are maintained with a suitable level liquid from the liquid supply vessel by the action of gravity, wherein the liquid supply vessel is disposed below the bottom surface of the rectangular bed directly under one of the at least two feed bowl openings, wherein a rimmed water bowl is disposed within the one feed bowl opening, wherein the rimmed water bowl comprises a bottom opening that allows water in the water bowl to enter the liquid supply vessel and wherein the bottom opening is provided with a ball float that closes when the liquid supply vessel is full.

6. The pet feeding device of claim 2 wherein each of the four liquid delivery tubes has a proximal end disposed within the liquid supply vessel and a distal end extending into a leg assembly reservoir wherein the distal end comprises a ball float that closes when the leg assembly reservoir is full.

7. The pet feeding device of claim 1 wherein the proximal ends of the outer tube elements are flared to provide a funnel cone that functions as an aid to adding liquid the support leg reservoirs.

8. The pet feeding device of claim 1 wherein the distal ends of the outer tube elements are flared to provide stabilizing feet to the leg assemblies.
